(19) United States
(12) Patent Application Publication
(10) Pub. No.: US 2017/0127662 A1
(43) Pub. Date: May 11, 2017

(54) Temperature Barrier for Blocking Housefly Maggots and Other Crawling Invertebrates

(71) Applicant: Thomas J. Gajdicar, Ottawa (CA)

(72) Inventor: Thomas J. Gajdicar, Ottawa (CA)

(21) Appl. No.: 14/934,231

(22) Filed: Nov. 6, 2015

(51) Int. Cl. A01M 1/10; B65F 1/14; B65F 1/16

(52) U.S. Cl. CPC A01M 1/103; B65F 1/1646; B65F 1/14; B65F 2001/1489

(57) ABSTRACT

An electrically heated barrier for containers storing organic waste that generates a temperature that blocks housefly maggots incubated in the container's waste from emerging to the exterior of the container, and that inhibits maggots and other crawling invertebrates on the exterior of the container from accessing the waste stored therein.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE

Not Applicable

### STATEMENT REGARDING PRIOR DISCLOSURES BY THE INVENTOR

Canadian Patent 2,856,811 granted and issued on 2015 Jul. 7
Filing Date: Jul. 10, 2014
Laid Open Date Sept. 25, 2014

### BACKGROUND OF THE INVENTION

This invention relates to containers used to store organic waste. In particular, this invention relates to means that block the emergence, from the container, of maggots present in the stored waste, and that inhibit maggots and other crawling invertebrates, on the exterior of the container, access to the contents therein by creating a temperature barrier using an electrically excited heating element.

Many organic waste recycling programs implemented by municipalities have encountered significant resistance from the public due to the problems incumbent in storing waste food and other organic material, particularly in warm weather conditions. The ability of houseflies or their newly hatched larvae to enter existing containers gives rise to the maggot problem, repugnant to most users who find dealing with maggots emerging from containers an experience to be avoided. Often the home owners who do participate in such waste recycling programs freeze their waste until the pickup day, or attempt to seal the openings of their containers with makeshift gaskets of pliable material such as plastic bags. Some resort to means that counter the degradability of the waste material by using bleach or other harmful chemicals. Many participants keep their containers outdoors, which is frequently not an option for that large segment of householders residing in town homes and older city neighborhoods. These householders often have porch, patio, or garage space near electrical outlets available to store containers and would be more inclined to use such space if maggots were unable to emerge from within.

It would be advantageous for a new container that would include an effective barrier that blocks the emergence of maggots established in the container. Alternatively, it would be advantageous for there to be a means for easily adapting existing containers to include the same feature.

A search of prior art failed to find any reference to the use of heat, and in particular electrically generated heat, as a means of blocking the migration of maggots and similar pests in enclosures that store organic waste.

German Patent Application DE 19747686 A1 by Uli Langen and Juergen Hoffmann, filed in 1997, discloses an insect larvae barrier comprising a liquid bearing tray disposed about the outlet of a waste receptacle.

A liquid barrier has limitations as maggots are quite capable of transporting themselves through most environmentally friendly liquids, including water. Other issues with this approach include spillage, maintaining a level liquid surface, and managing liquid with immersed maggots at the time the enclosure is emptied of its contents.

### SUMMARY OF THE INVENTION

The invention pertains to the use of a heating element to create a barrier that blocks the passage of housefly maggots and other crawling invertebrates in containers that store organic waste.

Maggot activity in organic waste occurs between temperatures of approximately 10 degrees Centigrade and 35 degrees Centigrade. Housefly maggots cannot tolerate temperatures much in excess of this temperature range. A barrier disposed circumferentially around the interior of a waste container, below its opening brim, at an appropriate temperature, blocks maggots below it from passing over it. Such a barrier also inhibits maggots and other crawling invertebrates, above the barrier, access to the contents therein.

High resistivity electrical conductors, using low voltage, low power sources, as can be supplied by the ubiquitous AC/DC power adaptor, readily achieve the necessary temperatures for the barrier dimensions required to block maggots in organic waste storage containers used by households, making the application of the invention suitable for residential use. Low voltage sources may also be appropriate for applying the invention to many containers as might be used in food processing establishments, apartment buildings, and composters.

Generally, this invention is directed to means that dispose a heating element circumferentially about the side walls of a container used to store organic waste, which, with an appropriate external electrical power source, generates a temperature that blocks maggots, present in the waste, crossing over the heating element. The two ends of the heating element terminate with a small gap between them at a terminal junction that provides a power connector to mate with the connector from the external power source. The width of the gap is dimensioned to allow the heating element, by way of heat conduction, to maintain the gap at a temperature that blocks maggots passing through it as well. A means to maintain the temperature of the heating element in a specific range as the ambient temperature of the container varies may be integrated into the electrical circuitry.

In one aspect the invention is directed to an insert that is dimensioned to fit into the opening of an container so that the exterior surface of the insert is in snug contact with the interior surface of the container when the insert is inserted into the container, so as to prevent maggots from by-passing the blocking temperature generated by the heating element.

In a second aspect, this invention is directed to a lid for a container, the lid having a downwardly disposed flange dimensioned to protrude into the opening of the container so that the flange bears the heating element and is in snug contact with the interior surface of the container so as to prevent maggots from by-passing the blocking temperature generated by the heating element.

In a further aspect, this invention is directed to the side walls of a new or extant container.

### BRIEF DESCRIPTION OF THE DRAWINGS

FIG. 1 is a slant perspective view of an organic waste container insert according to the first embodiment of the invention.

FIG. 2 is a slant perspective view of an extant container and insert according to the first embodiment of the invention.

FIG. 3 is a simple schematic showing the terminal junction components according to all described embodiments of the invention.

FIG. 4 is a slant perspective view of a lid for an extant container according to the second embodiment of the invention.

FIG. 5 is a slant perspective view of an extant container and lid according to the second embodiment of the invention.

FIG. 6 is a slant perspective view of a container with partial cut-away according to the third embodiment of the invention.

### DETAILED DESCRIPTION OF THE INVENTION

While the following text presents a detailed descriptions of three embodiments of the invention, the legal scope of the invention is defined by the claims of this patent as numerous variations of the described embodiments could be implemented, using current technology or technology developed after the filing date of this invention which would still fall within the purview of the said claims.

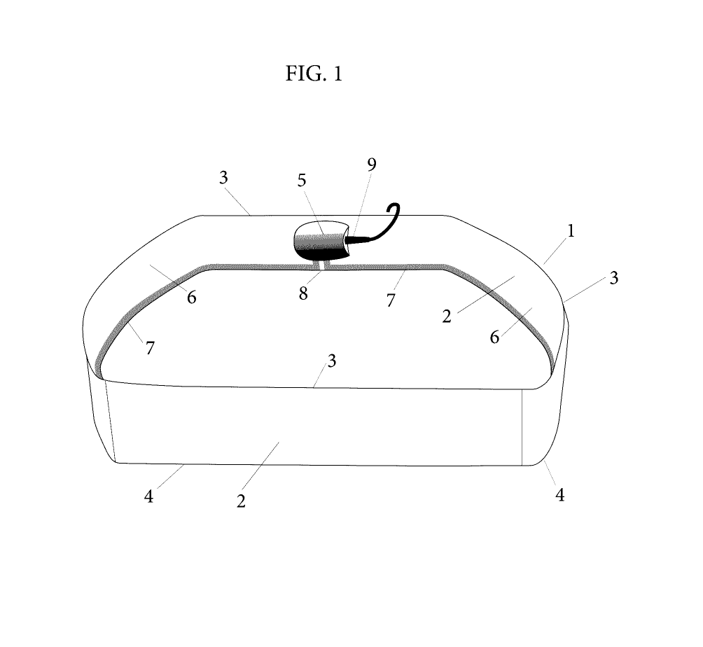

With reference to FIG. 1, the first embodiment of the invention is an insert 1, having; an insert wall 2, composed of an electrically non conducting material with insert wall upper edge 3, and insert wall lower edge 4; a terminal junction 5, disposed on the insert wall interior surface 6; and an heating element 7, disposed circumferentially about the insert wall 2. The two ends of the heating element 7 terminate at the terminal junction 5 with a small gap 8 between them. The terminal junction 5 may be connected to an external electrical power source connector 9.

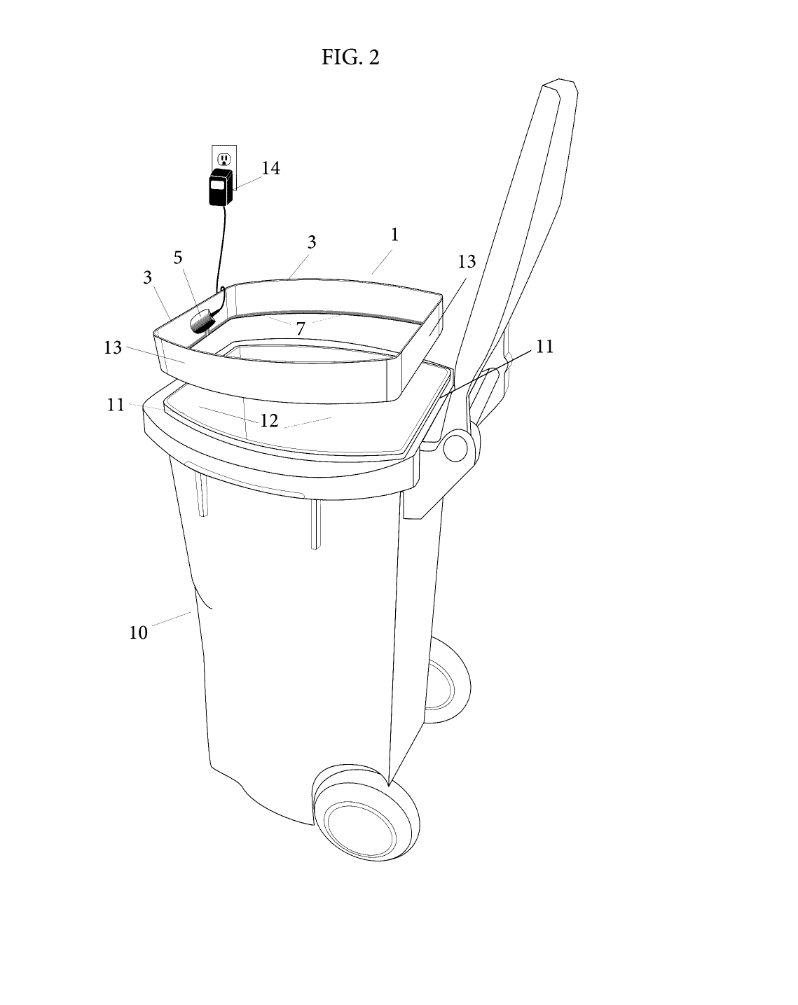

Referring to FIG. 2, the insert 1 is intended for insertion into a container 10 having a container brim 11 that generally defines a flat plane and a central cavity extending downwardly therefrom with generally vertical side walls that define the interior container surface 12. When insert 1 is inserted into the container 10, the insert wall exterior surface 13 fits snuggly against the interior container surface 12 so that the insert wall upper edge 3 runs approximately even with the container brim 11.

Referring to FIG. 1 and FIG. 2, the heating element 7 is an electrical conductor that may be imbedded in the insert wall 2, or disposed along the insert wall lower edge 4, or on the insert wall interior surface 6. The specific resistivity, length, and cross-sectional area of the heating element 7 are chosen to attain a temperature that prevents maggots from crossing the heating element 7, and the gap 8, throughout the range of ambient temperatures in which the insert 1 is specified to operate when the terminal junction 5 is connected to the external electrical power source 14 by means of the external electrical power source connector 9.

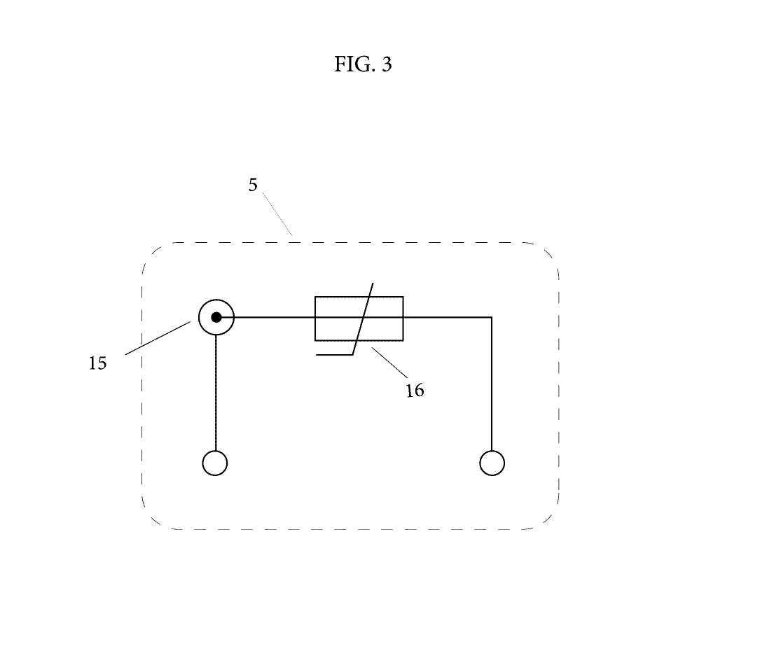

Referring to FIG. 1 and FIG. 3, an internal power connector 15 that may connect to the external power source connector 9, and a means of temperature control 16 that maintains the temperature of the heating element 7 within a specified range as the ambient temperature of the surrounding environment varies, are disposed within the terminal junction 5.

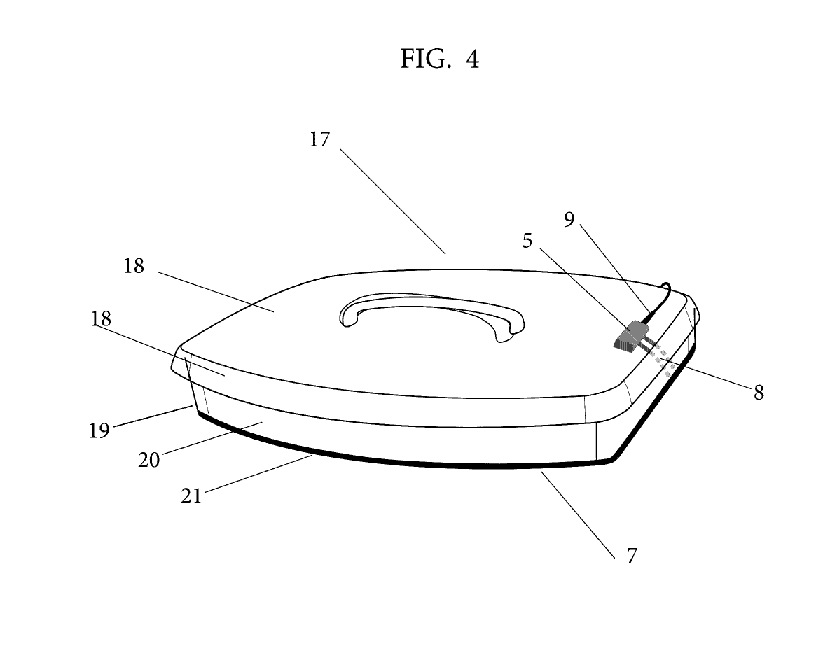

With reference to FIG. 4, the second described embodiment of the invention is a lid 17, comprising; a lid top 18 and a flange 19 composed of an electrically non conducting material with flange exterior surface 20 and flange lower edge 21; a terminal junction 5, disposed in the lid top 18; and a heating element 7, disposed circumferentially about the flange 19. The two ends of the heating element 7 terminate in the terminal junction 5 with a small gap 8 between them. The terminal junction 5 may be connected to an external electrical power source connector 9.

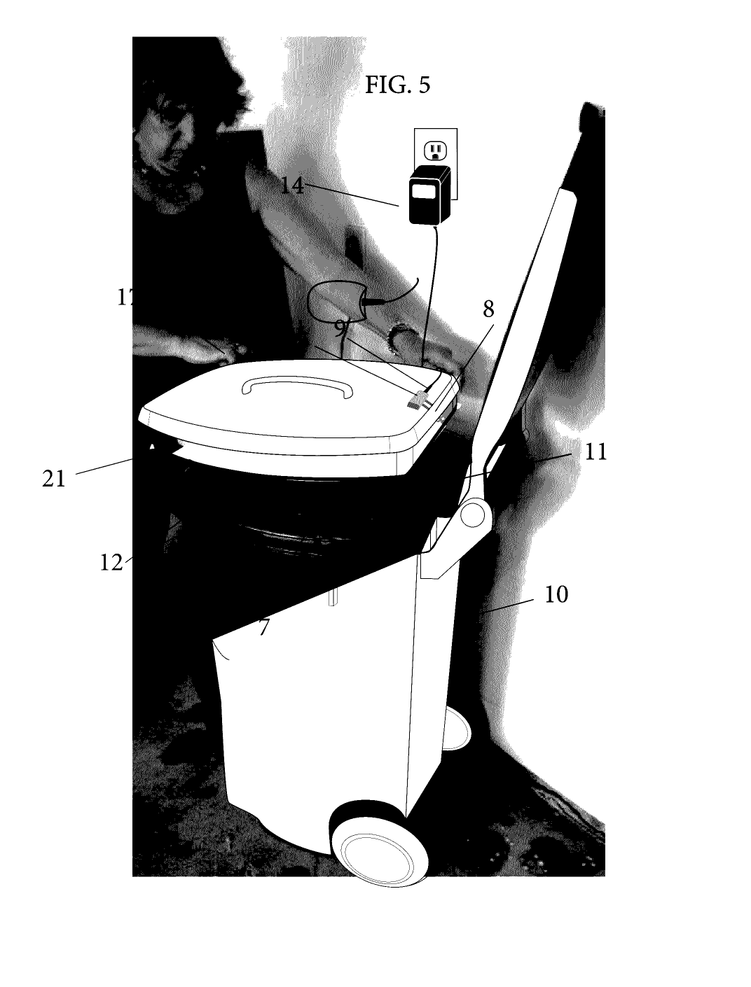

Referring to FIG. 5, the lid 17 is intended for insertion into a container 10 having a container brim 11 that generally defines a flat plane and a central cavity extending downwardly therefrom with generally vertical side walls that define the interior container surface 12. When the lid 17 is inserted into the container 10, the heating element 7 fits snuggly against the interior container surface 12.

Referring to FIG. 4 and FIG. 5, the heating element 7 is an electrical conductor and is disposed near or along the interior or exterior of the flange lower edge 21. The specific resistivity, length, and cross-sectional area of the heating element 7 are chosen to attain a temperature that prevents maggots from crossing the heating element 7 and the gap 8 throughout the range of ambient temperatures in which the lid 17 is specified to operate when the terminal junction 5 is connected to the external electrical power source 14 by means of the external electrical power source connector 9.

Referring to FIG. 3 and FIG. 4, an internal power connector 15 that may connect to the external power source connector 9, and a means of temperature control 16 that maintains the temperature of the heating element 7 within a specified range as the ambient temperature of the surrounding environment varies, are disposed within the terminal junction 5.

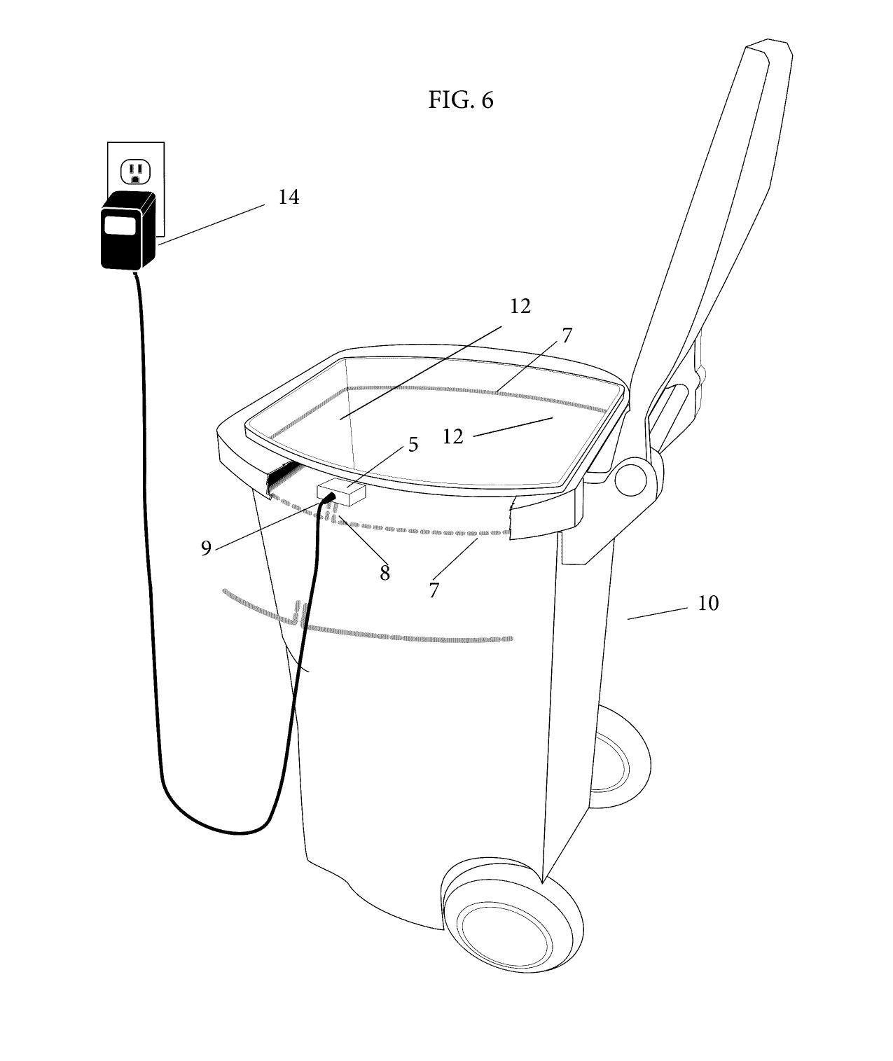

With reference to FIG. 6, the third embodiment of the invention is a container 10 composed of an electrically non conducting material having a container brim 11 that generally defines a flat plane and a central cavity extending downwardly therefrom with generally vertical container side walls that define the interior container surface 12; a terminal junction 5, disposed on or in the side wall of the container 10; and a heating element 7, disposed circumferentially about the interior container surface 12. The two ends of the heating element 7 terminate at the terminal junction 5 with a small gap 8 between them. The heating element 7 is an electrical conductor with specific resistivity, length, and cross-sectional area chosen to attain a temperature that prevents maggots from crossing the heating element 7, and the gap 8, throughout the range of ambient temperatures in which the container 10 is specified to operate when the terminal junction 5 is connected to the external electrical power source 14 by means of the external power source connector 9.

Referring to FIG. 3 and FIG. 6, a power connector 15 that may connect to the external power source connector 9, and a means of temperature control 16 that maintains the temperature of the heating element 7 within a specified range as the ambient temperature of the surrounding environment varies, are disposed within the terminal junction 5.

Although the invention has been described in terms of three possible embodiments, it should be understood that various modifications, additions, and alterations may be made to the invention by one skilled in the art without departing from the spirit and scope of the invention as defined in the appended claims.

1. An apparatus for creating a barrier that prevents the emergence of maggots and other crawling invertebrates from a container used to store organic waste, said container having an open top, a closed base and closed side walls, and said apparatus having an electrical junction, a heating element, and a temperature controller placed electrically in-line with said heating element, wherein said electrical junction may convey power from an external electrical power source to said heating element, and wherein said heating element is disposed circumferentially about the interior surface of said side walls so that when power is conveyed to said heating element, any maggot or other invertebrate crawling upward from said organic waste normally stored in said container must encounter a segment of surface area and/or said heating element that has attained a temperature that prevents further upward movement of said maggot or said invertebrate, and wherein said temperature controller may provide a means to maintain the temperature of said heating element within a specific temperature range as the ambient temperature of the surrounding environment varies.

2. The apparatus recited in claim 1, wherein said heating element is affixed to an insert for said container, said insert being thin-walled and dimensioned so that when said insert is inserted into said container, the exterior surface of said insert fits snuggly against the interior surface of said container.

3. The apparatus recited in claim 1, wherein said heating element is affixed to the downward protruding flange of a lid, said flange being thin-walled and dimensioned so that when said lid is placed onto said container, the said heating element abuts the interior surface of said container.

4. The apparatus recited in claim 1, wherein said heating element is affixed to the side walls of said container.
